(19) United States
(12) Patent Application Publication
(10) Pub. No.: US 2023/0019343 A1
(43) Pub. Date: Jan. 19, 2023

(54) Annotation Method of Arbitrary-Oriented Rectangular Bounding Box

(71) Applicant: CHINA INSTITUTE OF WATER RESOURCES AND HYDROPOWER RESEARCH, Beijing (CN)

(72) Inventors: Wenlong Song, Beijing (CN); Juan LV, Beijing (CN); Changjun LIU, Beijing (CN); Rui TANG, Beijing (CN); Tao SUN, Beijing (CN); Xiaotao LI, Beijing (CN); June FU, Beijing (CN); He ZHU, Beijing (CN); Yizhu LU, Beijing (CN); Long CHEN, Beijing (CN); Hongjie LIU, Beijing (CN)

(21) Appl. No.: 17/944,096

(22) Filed: Sep. 13, 2022

Related U.S. Application Data
(63) Continuation of application No. PCT/CN2020/079379, filed on Mar. 14, 2020.

(51) Int. Cl. G06V 10/26; G06V 10/46; G06V 10/24

(52) U.S. Cl. CPC G06V 10/26; G06V 10/467; G06V 10/24

(57) ABSTRACT

Disclosed in the present invention is An annotation method of arbitrary-oriented rectangular bounding box, wherein: the elements for annotation being: the coordinates of the center point C, a vector \vec{CD} formed by the center point C and a chosen vertex D, and the ratio of the vector \vec{CP} to vector \vec{CD}, where \vec{CP} is the projection of the vector \vec{CE} to \vec{CD}, and \vec{CE} is a vector formed by the center of the bounding box to one of the vertex E that close neighbor to vertex D; and it is also required that the vector \vec{CP} is in the same direction as the vector \vec{CD}, the vertex E in either of the clockwise or counterclockwise direction of the vertex D. The symbol notation of this method is (x_{c}, y_{c}, u, v, ρ), x_{c} and y_{c} are the two coordinate values of the center point C, u and v are the two components of vector \vec{CD}, ρ is the ratio of the vector \vec{CP} to vector \vec{CD}. Also let a binary value s to indicate whether the two components of the vector \vec{CD} have same sign or not to represent \vec{CD} and −\vec{CD} at once by (|u|, |v|, s), then getting a method for annotating arbitrary-oriented rectangular bounding box that one bounding box has only two representation vectors. Its symbol notation is (x_{c}, y_{c}, |u|, |v|, s, ρ), wherein |u| and |v| are magnitude of two components of the vector \vec{CD}. This method avoids loss inconsistency between representations of the same bounding box and is beneficial to model regression training.

### CROSS-REFERENCE TO RELATED APPLICATION

The present application is a continuation of International Application No. PCT/CN2020/079379, filed on Mar. 14, 2020, the content of which is hereby incorporated by reference in its entirety.

### TECHNICAL FIELD

The present invention relates to object detection and tracking algorithms in computer vision, especially for supervised-learning-based object detection and tracking algorithms. The method from this invention is one of the bounding box annotation methods in object detection and tracking algorithms. This rectangular bounding box annotation method can be used for bounding box output at predicting, taking as anchor boxes and annotating sample images.

### BACKGROUND ART

Object detection and tracking algorithms are of great value and have always been hot research topics. Recently, most often used bounding box is axis-aligned rectangular, it is annotated by the center point, width and height. There are several methods for annotating arbitrary-oriented rectangular bounding box. First one is the most commonly used technique which is axis-aligned rectangular with an additional angle value to x-axis or y-axis. The second method is from the thesis EAST An Efficient and Accurate Scene Text Detector (DOI: 10.1109/CVPR.2017.283), which uses the distances from the center to four edges of rectangular and a rotation angle. The third is listing the coordinates of four vertexes, which is also commonly used. This method can represent arbitrary quadrilateral, but has three redundancy variables for representing rectangular. The fourth, taking the first two vertexes of clockwise-ly ordered four vertexes of rectangular and the distance from the second vertex to the third vertex, reference from R²CNN: Rotational Region CNN for Orientation Robust Scene Text Detection. The fifth, using the parameters of axis-aligned Minimum Enclosing Rectangle of the bounding box and the gliding distances of the four vertexes between the axis-aligned Minimum Enclosing Rectangle and the bounding box, reference from Gliding vertex on the horizontal bounding box for multi-oriented object detection.

As to axis-aligned rectangular bounding box, the defects are obvious. Objects in aerial images are of large aspect ratio, arbitrary-oriented and densely-gathered. The intersection-over-union (IoU) between axis-aligned rectangular bounding boxes cannot truly represent the IoU between objects themselves. This situation is particularly significant for large vehicles in parking-lot and ships on harbor.

For the arbitrary-oriented bounding box annotated by axis-aligned rectangular bounding box with an additional angle value to x-axis or y-axis, when exchange the width and height and add 2kπ+π/2 to the angle, it's the same bounding box. Since one b-box has many numerical representations, there are many kinds of differences between the highly similar bounding boxes, and the difference between these representations means inconsistent loss of b-box regression, which adds difficulties to training. More about the shortcomings of this method can refer to SCRDet: Towards More Robust Detection for Small, Cluttered and Rotated Objects. The essence of the second method and the first method is the same. Replacing the width and height with the distances from the center to four edges of rectangular does not change anything, it has the same shortcomings.

Listing the coordinates of four vertexes can also leads to one bounding box has many representation vectors. One method to avoid the problem is sorting the vertexes by the coordinates, and the loss is calculated between corresponding vertexes. For more information, refer to DOTA: A Large-scale Dataset for Object Detection in Aerial Images. However, this can result in vector-component-misplacement, which means in one propagation the loss is calculated between the first component of prediction vector and the second component of target vector, but in another propagation the loss is calculated between the first component of prediction vector and the third component of target vector. The randomly correspondence is not conducive to training. The forth method is the third method with redundancy variables removed, therefore it also leads to the fact that one bounding box has many representation vectors.

The fifth method aimed to predict the axis-aligned Minimum Enclosing Rectangle of the bounding box at first and then fine-tune to the real rotated bounding box. When predicting the axis-aligned Minimum Enclosing Rectangle of bounding box, it serves as the target of the anchor box. If the rotated bounding box needs to be precisely predicted, the axis-aligned Minimum Enclosing Rectangle needs also be precisely predicted. This method adds the number of predicting targets, thereby increase the difficulties of prediction (regression). Thus it is not good for training either.

### SUMMARY OF THE INVENTION

In order to solve the problem of the inconsistent loss of b-box regression and the difficulty of model regression encountered in the above-mentioned technical, a new method for annotating arbitrary-oriented rectangular bounding box is proposed, wherein

the elements for annotation being the coordinates of the center point C, a vector \vec{CD} formed by the center point C and a chosen vertex D, and the ratio of the vector \vec{CP} to vector \vec{CD}, where \vec{CP} is the projection of the vector \vec{CE} to \vec{CD}, and \vec{CE} is a vector formed by the center of the bounding box to one of the vertex E that close neighbor to vertex D; the vector \vec{CP} is in the same direction as the vector \vec{CD}, and the vertex E in either of the clockwise or counterclockwise direction of the vertex D; the symbol notation of this method is (x_{c}, y_{c}, u, v, ρ), x_{c} and y_{c} are the two coordinate values of the center point C, u and v are the two components of vector \vec{CD}, ρ is the ratio of the vector \vec{CP} to vector \vec{CD}.

Of the method described above, there are only two representation vectors of one bounding box. In other words, taking the opposite vector of \vec{CD} and leaving the rest unchanged is still represents the same bounding box. Because only the vectors \vec{CD} of the two representations are in the opposite direction, they can be represented at once. Using a binary value s to indicate whether the two components of the vector \vec{CD} are all positive (or negative) or a positive and a negative (hereinafter referred to same sign or different sign), then \vec{CD} and −\vec{CD} can be represented by (|u|, |v|, s) at once, wherein |u| and |v| are magnitude of two components of the vector \vec{CD}. If the two components are of same sign, \vec{CD} and −\vec{CD} are (|u|, |v|) and (−|u|, −|v|). If the two components are of different sign, \vec{CD} and −\vec{CD} are (−|u|, |v|) and (|u|, −|v|). Now, we can reduce the number of representation vectors of one bounding box to one, its symbol notation is (x_{c}, y_{c}, |u|, |v|, s, ρ).

Thus a refinement version of this invention is using a binary value s to indicate whether the two components of the vector CD are all positive (or negative) or a positive and a negative, and making \vec{CD} and −\vec{CD} be represented by (|u|, |v|, s) at once.

Advantageous effects of the present invention are that it avoids loss inconsistency between representations of the same bounding box and is beneficial to model regression training. The present invention provides a method for annotating arbitrary-oriented rectangular bounding box that one bounding box has only two representation vectors, and only the (u, v) of the two representations are opposite numbers. There left only one representation vector, if using a binary value s to indicate whether the two components of the vector \vec{CD} have same sign or not. The present invention avoids loss inconsistency and is beneficial to training. Other than that, the correspondence of components of representation vector does not need to be adjusted.

Hereinafter, the present invention will be described in detail with reference to the accompanying drawings and examples.

### BRIEF DESCRIPTION OF THE DRAWINGS

FIG. 1 is a schematic diagram showing an arbitrary-oriented bounding box annotation method;

FIG. 2 is a schematic diagram showing the loss between predicted \vec{CD*} and background truth \vec{CD}.

### DETAILED DESCRIPTION OF THE INVENTION

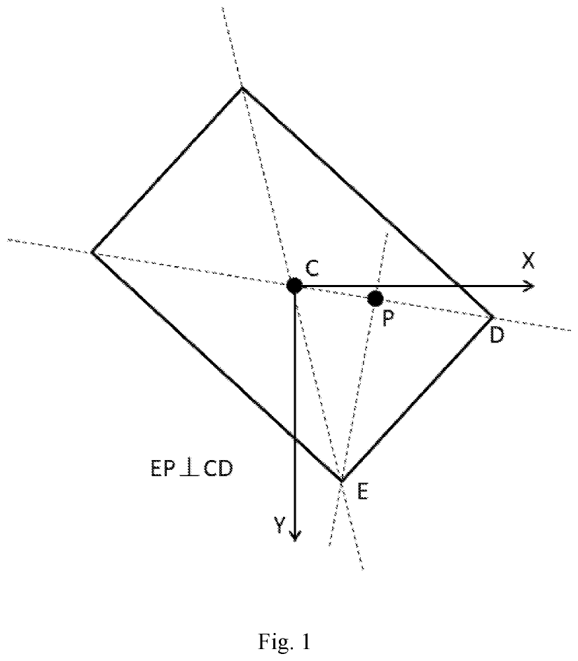

In FIG. 1, X represents coordinate axis in an image row direction, Y represents the coordinate axis in an image column direction, C represents a center point of the bounding box, D, E are some two vertexes of the bounding box, P represents the projection point of \vec{CD} on \vec{CE}.

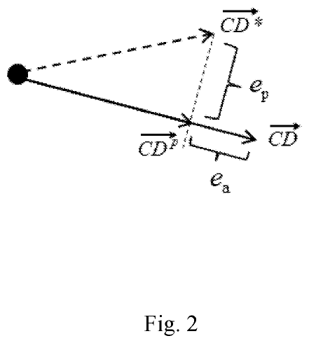

In FIG. 2, CD represents the vector from the center point of the bounding box to the vertex D, \vec{CD*} is the prediction of \vec{CD}, \vec{CP} is the projection vector of \vec{CD*} on \vec{CD}, eₚ is the length of the difference vector of \vec{CD*} and \vec{CP}, eₐ is the length difference between \vec{CD} and \vec{CP}.

An annotation method of arbitrary-oriented rectangular bounding box that used for taking as anchor boxes, annotating sample images and bounding box output at predicting of target detection and tracking algorithm, wherein

the elements for annotation being the coordinates of the center point C, a vector \vec{CD} formed by the center point C and a chosen vertex D, and the ratio of the vector \vec{CP} to vector \vec{CD}, where \vec{CP} is the projection of the vector \vec{CE} to \vec{CD}, and \vec{CE} is a vector formed by the center of the bounding box to one of the vertex E that close neighbor to vertex D; the symbol notation of this method is (x_{c}, y_{c}, u, v, ρ), x_{c}, and y_{c}, are the two coordinate values of the center point C, u and v are the two components of vector \vec{CD}, ρ is the ratio of the vector \vec{CP} to vector \vec{CD}.

To reduce the number of representation vectors, the value range of ρ required to be in [0,1), i.e. the vector \vec{CP} is in the same direction as the vector \vec{CD}, the vertex E in either of the clockwise or counterclockwise direction of the vertex D. With this constraint, there are only two representation vectors of one bounding box. In other words, taking the opposite vector of \vec{CD} and leaving the rest unchanged is still represents the same bounding box.

Since one bounding box still has two representation vectors, means are needed to avoids loss inconsistency, a loss function that produce the same output of the prediction between the two representation vectors should be provided. Because only the vectors \vec{CD} of the two representations are in the opposite direction, letting the loss value of the prediction \vec{CD*} between \vec{CD} and −\vec{CD} be the same will achieve the goal. Let \vec{CP} be the projection vector of \vec{CD*} on \vec{CD}, then an available loss function can be:

|\vec{CD*}−\vec{CP}|+||\vec{CD}|−|\vec{CP}||

As shown in FIG. 2, |\vec{CD*}−\vec{CP}| is the length of the difference vector of \vec{CD*} and \vec{CP}, ||\vec{CD}|−|\vec{CP}|| is the length difference between \vec{CD} and \vec{CP}.

Because only the vectors \vec{CD} of the two representations are in the opposite direction, they can be represented at once. Using a binary value s to indicate whether the two components of the vector \vec{CD} are all positive (or negative) or a positive and a negative (hereinafter referred to same sign or different sign), then \vec{CD} and −\vec{CD} can be represented by (|u|, |v|, s) at once, wherein |u| and |v| are magnitude of two components of the vector \vec{CD}. If the two components are of same sign, \vec{CD} and −\vec{CD} are (|u|, |v|) and (−|u|, −|v|). If the two components are of different sign, \vec{CD} and −\vec{CD} are (−|u|, |v|) and (|u|, −|v|). Now, we can reduce the number of representation vectors of one bounding box to one, its symbol notation is (x_{c}, Y_{c}, |u|, |v|, s, ρ).

Since the representation vector has been reduced to one, the calculation of the loss will be more convenient. When predicting a target box directly, the loss of x_{c}, Y_{c}, |u|, |v|, s, ρ can be calculated in a regression way, that is, the difference between values is directly calculated, such as SmoothL1, L2, etc. The loss of s can be calculated in a classified way, so that the model outputs two values for s, indicating the possibility of taking the same sign and the different sign. If the value representing the same sign is bigger, the two components are of same sign, otherwise the opposite. The loss function can be CorssEntropy, L2, etc.

When using the feature vector to predict the regression parameters of the anchor box to the target box, it is possible to artificially stipulate that the anchor box of the same sign regress to the target box of the same sign, and the anchor box of the different sign regress to the target box of the different sign. Then there is no need to calculate the loss of s.

When use this method to annotate axis-aligned rectangular b-box, we can find that the two components of the vector \vec{CD} are the half of the width and the height. So, let (u, v)=2\vec{CD} makes this method be compatible with the axis-aligned rectangular annotated by the center point, width and height.

With this annotation method, we can calculate the four vertexes of rectangular by solve the following equations. The coordinates of \vec{CE} is unknown, after \vec{CE} is solved the coordinates of the vertexes can be calculated by doing addition and subtraction of vectors.

$$\{ \begin{matrix}( {CE}^{⟶} - ρ {CD}^{⟶} ) \cdot {CD}^{⟶} = 0 \\ \vert {CE}^{⟶} \vert = \vert {CD}^{⟶} \vert\end{matrix} s . t . {CE}^{⟶} \times {CD}^{⟶} \geq 0 or {CE}^{⟶} \times {CD}^{⟶} \leq 0$$

Where the first equation means \vec{EP} is perpendicular to \vec{CD}, the second equation means the length of CE and CD are identical, the constraint means the vertex E in either of the clockwise or counterclockwise direction of the vertex D. Only one of \vec{CE}×\vec{CD}≥0 and \vec{CE}×\vec{CD}≤0 can be taken.

One embodiment thereof is: when annotating the sample image, the value of x_{c}, y_{c}, |u|, |v| is normalized according to image width (wᵢ) and height (hᵢ). For compatibility with the axis-aligned rectangular annotated by the center point, width and height, expand |u| and |v| by a factor of 2. Then the corresponding value of the target bounding box in the annotated document is x_{c}/wᵢ, y_{c}/hᵢ, 2|u|/wᵢ, 2|v|/hᵢ, d, ρ.

Another embodiment thereof is: When we artificially stipulate that the anchor box of the same sign regress to the target box of the same sign, and the anchor box of the different sign regress to the target box of the different sign. The regression parameters from the anchor box to the target box can be defined using the following formula:

tₓ=(x*_{c}−x_{c}^{a})/wₐ, t_{y}=(y*_{c}−y_{c}^{a})/hₐ

tᵤ=ln(|u|*/|u|^{a}),tᵥ=ln(|v|*/|v|^{a}),t_{ρ}=ln(ρ*/ρ^{a})

Wherein, x*_{c}, y*_{c}, |u|*, |v|* and ρ* are parameters of target box, x_{c}^{a}, y_{c}^{a}, |u|^{a}, |v|^{a} and ρ^{a} are parameters of pre-setting anchor box, tₓ, t_{y}, tᵤ, tᵥ and t_{ρ} are the regression parameters that transforms the anchor box into the target box, and is also the value that the model needs to output directly.

1. An annotation method of arbitrary-oriented rectangular bounding box, characterized in that the elements for annotation being:
the coordinates of the center point C, a vector \vec{CD} formed by the center point C and a chosen vertex D, and the ratio of the vector CP to vector \vec{CD}, where \vec{CP} is the projection of the vector \vec{CE} to \vec{CD}, and \vec{CE} is a vector formed by the center of the bounding box to one of the vertex E that close neighbor to vertex D; the vector \vec{CP} is in the same direction as the vector \vec{CD}, and the vertex E in either of the clockwise or counterclockwise direction of the vertex D; the symbol notation of this method is (x_{c}, y_{c}, u, v, ρ), x_{c} and y_{c} are the two coordinate values of the center point C, u and v are the two components of vector \vec{CD}, ρ is the ratio of the vector \vec{CP} to vector \vec{CD}.

2. The annotation method of arbitrary-oriented rectangular bounding box according to claim 1, characterized in that:
using a binary value s to indicate whether the two components of the vector \vec{CD} are all positive (or negative) or a positive and a negative, and making \vec{CD} and −\vec{CD} be represented by (|u|, |v|, s) at once, which leads to on bounding box has only one representation vector; the symbol notation is (x_{c}, y_{c}, |u|, |v|, s, ρ) , wherein |u| and |v| are magnitude of two components of the vector \vec{CD}.

3. The annotation method of arbitrary-oriented rectangular bounding box according to claim 1, characterized in that:
let (u, v)=2\vec{CD} makes this method compatible with the axis-aligned rectangular annotated by the center point, width and height, its symbol notation is (x_{c}, y_{c}, 2|u|, 2|v|, s, ρ).

4. The annotation method of arbitrary-oriented rectangular bounding box according claim 2, characterized in that:
let (u, v)=2\vec{CD} makes this method compatible with the axis-aligned rectangular annotated by the center point, width and height, its symbol notation is (x_{c}, y_{c}, 2|u|, 2|v|, s, ρ).
